(19) United States
(12) Patent Application Publication
(10) Pub. No.: US 2014/0361138 A1
(43) Pub. Date: Dec. 11, 2014

(54) CUBE POSTER HOLDER

(71) Applicants: Cecilia RAMIREZ, El Paso, TX (US); Jose RAMIREZ, El Paso, TX (US)

(72) Inventors: Cecilia RAMIREZ, El Paso, TX (US); Jose RAMIREZ, El Paso, TX (US)

(21) Appl. No.: 13/911,417

(22) Filed: Jun. 6, 2013

(51) Int. Cl. G09F 15/00; F16M 11/20; F16M 11/42; F16M 11/04

(52) U.S. Cl. CPC G09F 15/0068; F16M 11/041; F16M 11/2014; F16M 11/42
USPC 248/469

(57) ABSTRACT

A cube shaped poster board holder comprising: a four sided cube; a pedestal, where pedestal supports the cube; and a base, where the pedestal mounts on top of the base and rotates the cube in circular motion. Each side of the cube may include a clip, where the clip receives a poster board. The base may include wheels, where the wheels enable movement of the poster board holder over a surface and in the preferred embodiment the base is rectangular in shape.

### BACKGROUND OF THE INVENTION

1. Field of Invention

The present invention relates to a cube shaped display holder for use with poster boards.

2. Description of Related Art

Many teachers or presenters use charts in the form of sheets of paper on a clip poster board. Consequently, these clip poster board display mechanisms are useful in teaching and group presentations. Many times individuals post lists associated the subject matter of teaching lesson or presentation. Consequently over a course of a presentation many sheets may be presented for viewing at various times during the presentation or class. Further, many school teachers use charts and keep the charts posted during a classroom lesson. Most classrooms may include a chalkboard and anchor board for posting posters along the wall. It would be advantageous to have a device that could provide an additional mechanism to post poster boards and anchor them during a classroom lesson or other presentation.

### SUMMARY OF THE INVENTION

The present invention relates to a cube shaped poster board holder comprising: a four sided cube; a pedestal, where pedestal supports the cube; and a base, where the pedestal mounts on top of the base and rotates the cube in circular motion. Each side of the cube may include a clip, where the clip receives a poster board. The base may include wheels, where the wheels enable movement of the poster board holder over a surface and in the preferred embodiment the base is rectangular in shape.

### BRIEF DESCRIPTION OF DRAWINGS

FIG. 1 depicts a perspective view of a cube shaped poster pedestal in accordance with the present invention.

### DETAILED DESCRIPTION

The present invention relates to a cube shaped poster holder mounted on a rotating pedestal to hold poster boards and anchor charts for display during a class or a presentation. The present invention has a cube shape and therefore four sides of the cube are used for mounting poster boards. The bottom portion of the cube is mounted on a rotating pedestal that is attached to a square base. The base also includes wheels so that the entire assembly is easily moved and rotated. Each side includes a clip for the anchoring of a poster board and therefore is very effective in providing a pedestal cube-shaped device that is useful for the mounting of the poster board.

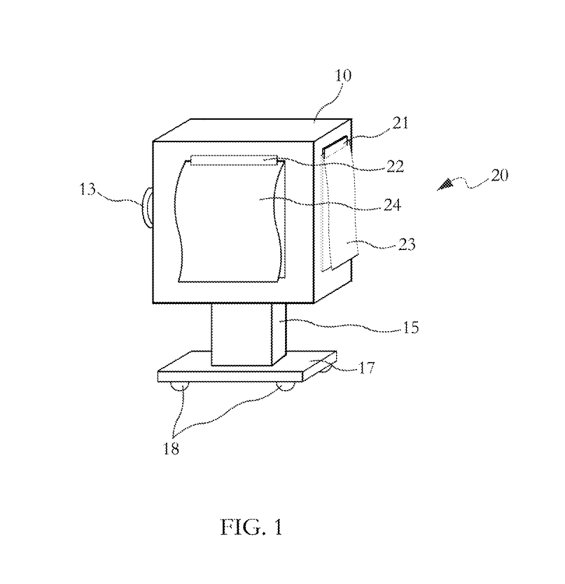

In reference to FIG. 1, Poster Board Cube 20 is depicted. The Poster Board Cube 20 includes four sides and a Top Surface 10. Each side of the Cube 20 includes a clip, shown as Clips 21, 22, which hold a poster board in place on each side of the Cube 20. Poster Boards 23, 24 are shown on the two sides that are visible in FIG. 1. The Cube 20 is mounted on a Pedestal 15. The Pedestal 15 rotates in order to view the other opposing sides of the Cube 20. The Pedestal 15 is mounted on a Rectangular Base 17. The Rectangular Base 17 includes Wheels 18 shown at the bottom side of the Base 17. Although two wheels are shown in FIG. 1 in one particular embodiment four wheels are provided at the base to allow for the movement of the poster board cube assembly over a flat surface. The poster board assembly also includes Handles 13, which extend from one side of the Cube 20. The handle helps user to maneuver the Poster Board Cube 20 as desired.

The poster board cube in accordance with the present invention provides a straightforward device to display charts and posters, and expands the poster mounting capabilities of a teacher in a classroom environment or presenter during a presentation. The instant invention has been shown and described in what it considers to be the most practical and preferred embodiments. It is recognized, however, that departures may be made there from within the scope of the invention and that obvious modifications will occur to a person skilled in the art.

1. A cube shaped poster board holder comprising:
a. a four sided cube;
b. a pedestal, where pedestal supports the cube; and
c. a base, where the pedestal mounts on top of the base and rotates the cube in circular motion;
d. a set of wheels below the base, where the set of wheels enable movement of the poster board holder over a surface;
e. at least one clip on a top of a side of the cube, where the clip receives and displays a poster board; and
f. a handle on a side of the cube, where the handle maneuvers the poster board holder as desired.

2. The cube shaped poster board according to claim 1, where a clip is on each side of the cube.

3. (canceled)

4. The cube shaped poster board according to claim 1, where the base is rectangular in shape.

5. The cube shaped poster board according to claim 1, where the base includes four wheels.

6. (canceled)
